(19) United States
(12) Patent Application Publication
(10) Pub. No.: US 2001/0015029 A1
(43) Pub. Date: Aug. 23, 2001

(54) Tungsten fishing equipment and methods

(76) Inventors: David C. Carter, Benton, AR (US); Alan S. Hilborn, Benton, AR (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/757,350

(22) Filed: Jan. 8, 2001

Related U.S. Application Data
(62) Division of application No. 09/312,406, filed on May 14, 1999.

(51) Int. Cl. A01K 83/06

(52) U.S. Cl. 43/44.81

(57) ABSTRACT

The invention provides fishing weights as well as methods for manufacturing and using such fishing weights. One fishing weight comprises a body having a defined outer shape and an opening extending through the body. The opening is adapted to receive a fishing line. The body is constructed from a composition comprising tungsten in major amount and nickel binder in minor amount.

### BACKGROUND OF THE INVENTION

This invention relates generally to the field of fishing, and in particular to fishing weights or sinkers. More specifically, the invention relates to the use of tungsten to construct fishing weights.

Fishing has long been a popular sport and involves the use of various equipment and tackle. Of particular interest to the invention are fishing systems utilizing a fishing pole, a reel and a line. Attached to the line is one or more hooks that may be employed to catch a fish. The hook may be configured to receive a type of bait, such as a worm, cheese, or the like. Alternatively, the hook may be incorporated into a type of artificial lure, e.g., a fly, a jig, spinner bait, a spoon, and the like.

In many cases, a need exists to enhance the sinking ability of the bait or artificial lure. A variety of weights or sinkers have been developed to enhance the sinking ability. For example, weights exist that may be coupled to the fishing line. The weights assist in moving the hook or artificial lure deeper within the water.

A common material used to construct such weights is lead. One significant drawback to the use of lead weights is that they are not environmentally safe. For example, stray weights may be ingested by waterfowl, thereby posing a significant health risk to the waterfowl. As such, some (including the state of New Hampshire and Yellowstone National Park) have banned the use of lead when fishing in those waters. It is anticipated that other organizations within the U.S. will soon implement such a ban.

As an alternative to lead weights, some have proposed the use of brass weights. However, the use of brass may require a machining process to produce the weights, thereby making the use of brass less desirable.

Hence, it would be desirable to provide a workable alternative to traditional lead weights for fishing. Such weights should be environmentally safe and economically viable.

### SUMMARY OF THE INVENTION

The invention provides exemplary fishing weights, fishing lures and methods for making and using such fishing weights and fishing lures. In one embodiment, the invention provides a fishing weight which comprises a body having a defined outer shape and an opening extending through the body. The opening is provided so that a fishing line may be inserted through the body. Further, the body is constructed from a composition comprising a tungsten powder in major amount and a nickel binder in minor amount. When the composition is fired, a tungsten carbide body is formed.

In one aspect, the composition comprises about 80 wt. % to about 97 wt. % tungsten powder and about 20 wt. % to about 3 wt. % nickel binder. In another aspect, the body has a center section that is cylindrical in geometry. In yet another aspect, the body has two ends which may have a variety of geometries. For example, the ends may be concave, pointed, convex, flat, and combinations thereof. In another alternative, the body is spherical in geometry. In still another aspect, the opening has a diameter in the range from about 0.035 inch to about 0.080 inch.

The invention further provides an exemplary method for producing a fishing weight. In one step of the method, a composition comprising a tungsten powder in major amount and a binder in minor amount is placed into a die. The composition is compressed within the die to form a green body. The green body is then removed from the die and is heated to form a tungsten carbide fishing weight.

In one aspect, the composition comprises about 80 wt. % to about 97 wt. % tungsten powder, about 20 wt. % to about 3 wt. % nickel binder, and about 1 wt. % to about 3 wt. % wax. In another aspect, the fishing weight is tumbled in an abrasive slurry after being removed from the die. In another step, the fishing weight is washed following smoothing by the abrasive slurry.

In yet another aspect, the green body is heated to a temperature in the range from about 1450° C. to about 1490° C. The composition may be compressed under a pressure in the range from about 1 ton to about 5 tons.

In still yet another aspect, the die is cylindrical in geometry and the composition is compressed by placing a punch into one end of the cylinder and an ejector into an opposite end of the cylinder and compressing the composition between the punch and the ejector. Conveniently, the punch and the ejector may have shaped surfaces to form shaped ends on the resulting weight. One convenient way to remove the green body from the die is to move the ejector through the die. In one aspect, a center rod may be placed along a central axis of the die to form a central hole in the green body. The center rod is preferably removed prior to firing of the green body.

In still another embodiment, the invention provides a method for fishing which employs the use of a pole having a reel and a line. The method also utilizes a weight which comprises a body having an outer shape and an opening extending through the body. The body is constructed from a composition comprising tungsten in major amount and a nickel binder in minor amount. The line is inserted through the opening, and a hook is secured on the end of the line. The hook and the weight are then cast into a body of water.

Optionally, a disk may be placed onto the line prior to securing the hook. In this way, the line may be pulled through the water to permit the disk to interact with the weight to produce sound waves within the water. In one aspect, the disk has a diameter that is approximately equal to the diameter of the weight. In still another aspect, the disk is constructed of a material that is approximately the same as the material used to construct the weight.

Another embodiment of the invention provides a fishing lure which comprises a hook and a body coupled to the hook. The body is constructed from a composition comprising tungsten in major amount and a nickel binder in minor amount. In one aspect, the body includes two sections that are coupled to each other about the hook. In this way, the body may be manufactured in two pieces which are then secured together to form the body about the hook.

### BRIEF DESCRIPTION OF THE DRAWINGS

FIG. 1A is a top perspective view of one embodiment of a fishing weight according to the invention.

FIG. 1B is an end view of the fishing weight of FIG. 1A.

FIG. 2 is a top perspective view of an alternative fishing weight according to the invention.

FIG. 3 is a top perspective view of still another embodiment of a fishing weight according to the invention.

FIG. 4A is a side view of yet another alternative embodiment of a fishing weight according to the invention.

FIG. 4B is a side perspective view of the fishing weight of FIG. 4A.

FIG. 5A is a top view of an ejector according to the invention.

FIG. 5B is a side view of the ejector of 5A taken along lines B-B.

FIG. 6A is a top view of a punch according to the invention.

FIG. 6B is a cross-sectional side view of the punch of FIG. 6A taken along lines B-B.

FIG. 7A is a top view of a core rod according to the invention.

FIG. 7B is a cross-sectional side view of the core rode of FIG. 7A taken along lines B-B.

FIG. 8A is a top view of a die according to the invention.

FIG. 8B is a cross-sectional side view of the die of FIG. 8A taken along lines B-B.

FIG. 9 is a flow chart of one method that may be used to produce a fishing weight according the invention.

FIG. 10A is a side view of an alternative fishing weight according to the invention.

FIG. 10B is a cross-sectional side view of the fishing weight of FIG. 10A taken along lines B-B.

FIG. 11A is a top view of a clacker according the invention.

FIG. 11B is a cross-sectional side view of the clacker of FIG. 11A taken along line B-B.

FIG. 12 is an exploded side view of a jig according to the invention.

FIG. 13 is a cross-sectional side view of the jig of FIG. 12.

### DESCRIPTION OF THE SPECIFIC EMBODIMENTS

The invention provides exemplary fishing weights along with methods for making and using such fishing weights. The fishing weights of the invention may be coupled to a fishing line or may be incorporated as part of a fishing lure. For example, the fishing weight may be incorporated into lures such as jigs, spinner baits, plugs, and the like.

In one embodiment, the fishing weights of the invention may be constructed from a composition comprising tungsten in major amount and a binder in minor amount. The tungsten and binder composition is compressed to form a green body which is subsequently fired to form a tungsten carbide fishing weight.

In one specific embodiment, weights are constructed using a tungsten-powder in combination with a binder. The composition may include about 80 wt. % to about 97 wt. % tungsten powder and about 20 wt. % to about 3 wt. % nickel binder. An examples of a commercially available powder that may be used includes a 6% Ni Grade tungsten powder, commercially available from Osram.

One particular binder that may be employed is a nickel binder. One advantage of nickel is that it is environmentally safe. The composition used to form the green body may also include a wax, such as bees wax or paraffin wax. When used within the composition, the wax helps to hold the green body together prior to firing.

One particular composition that may be used to form fishing weights comprises about 80 wt. % to about 97 wt. % tungsten powder, about 3 wt. % to about 20 wt. % nickel and about 1 wt. % to about 3 wt. % wax.

The tungsten carbide fishing weights of the invention provide a number of significant advantages over lead fishing weights. For instance, the tungsten fishing weights of the invention may be configured to be about 25% smaller than a lead weight of similar size, thus creating fewer hang-ups and less drag when fishing. As another example, when the tungsten weights of the invention strike an object in water, they produce a sound which is approximately twice as loud as lead. Such a feature helps to attract fish. Another important advantage is that tungsten weights are environmentally safe and do not pose significant health hazards to wildlife.

The fishing weights of the invention may be configured to have a wide variety of shapes and sizes. Merely, by way of example, the weights of the invention may have shapes shown in FIGS. 1-4. FIGS. 1A and 1B illustrate one embodiment of a weight 10 having a generally cylindrical body 12 and generally hemispherical ends 14 and 16. Extending between ends 14 and 16 is a through hole 18 through which a fishing line may be inserted. As described in greater detail hereinafter, body 12 may be constructed to be cylindrical in geometry for convenience of manufacturing e.g., by using a generally cylindrical die to form weight 10.

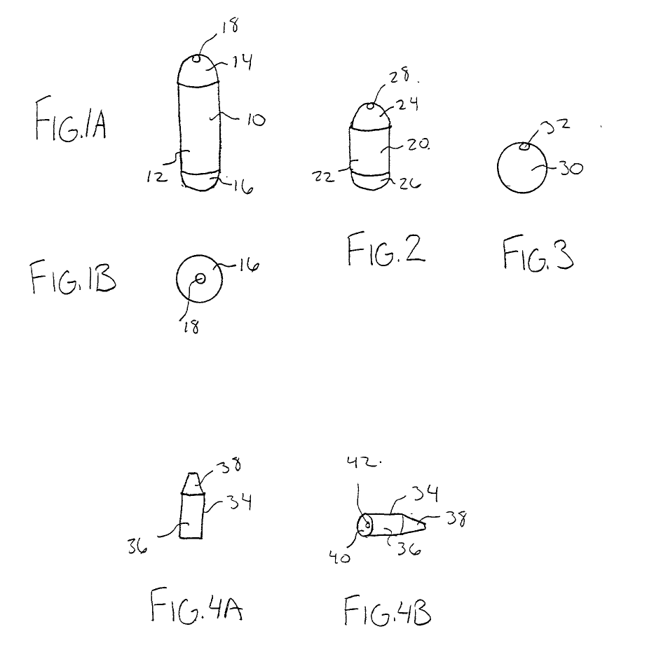

Shown in FIG. 2 is a weight 20 having a cylindrical body 22, ends 24 and 26 and a through hole 28. Weight 20 is similar to weight 10 except that the length of body 22 is shorter than the length of body 12. In this way, weight 20 has a smaller mass. As described hereinafter, construction of the weights to have different sizes may be accomplished by simply placing less material within the same die.

As shown in FIG. 3, the cylindrical-shaped body portion may be eliminated altogether to form a generally spherical weight 30. Extending through weight 30 is a through hole 32.

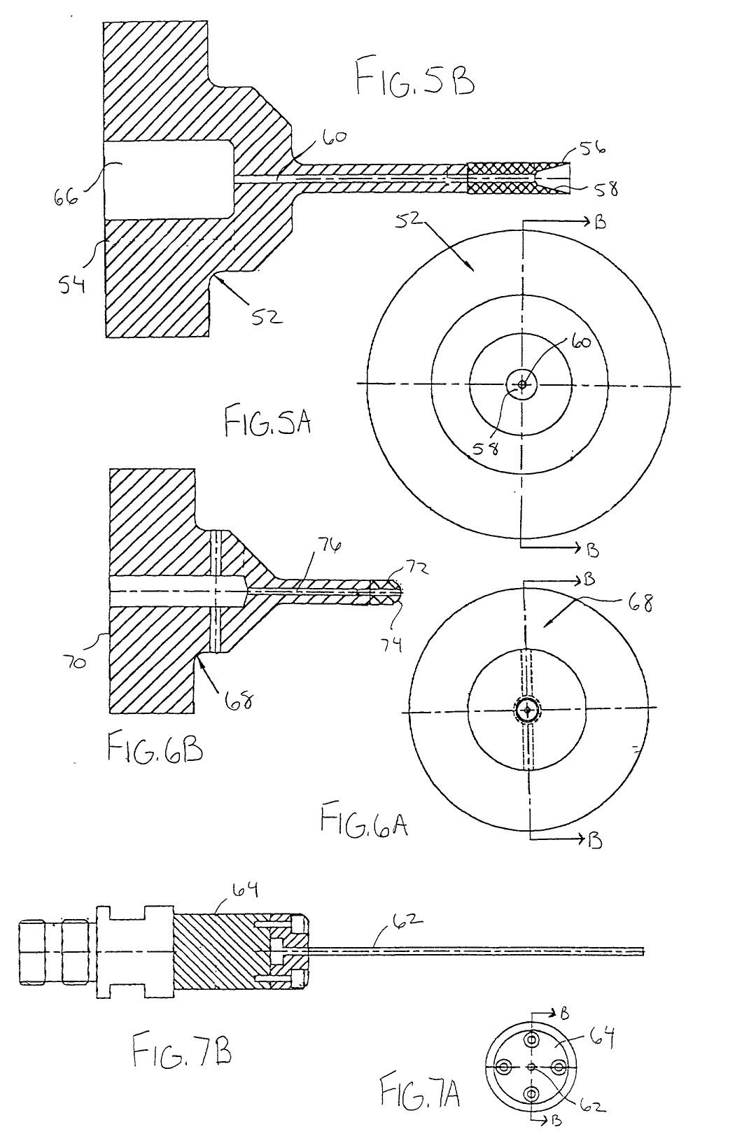

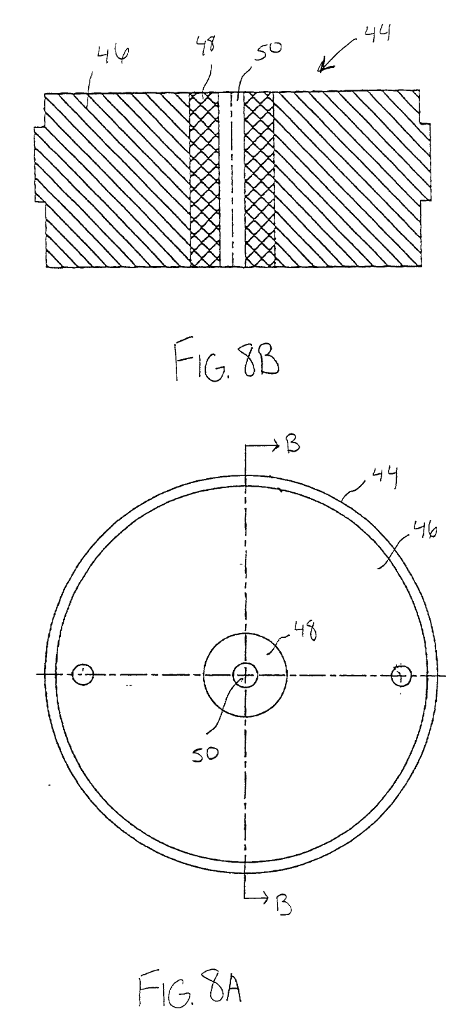

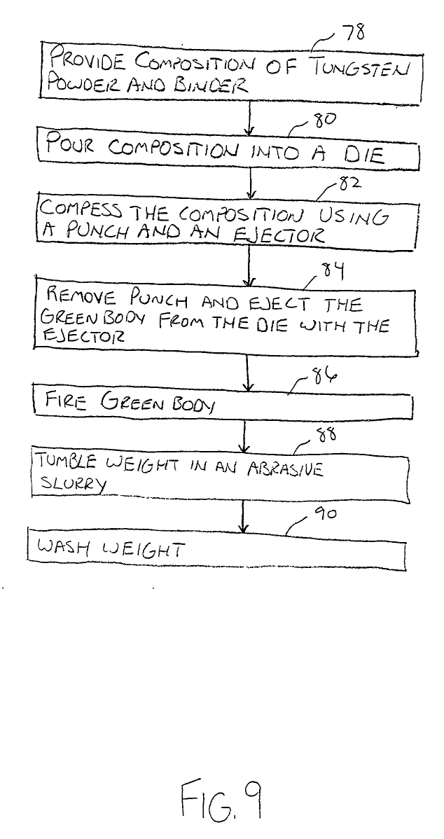

Shown in FIGS. 4A and 4B is another embodiment of a weight 34 having a generally cylindrical-shaped body 36. Weight 34 further includes a pointed tip 38 and an end 40 to form a bullet shape. End 40 may be configured to be flat in geometry or concave as shown in FIG. 4B. A through hole 42 extends through weight 34.

The weights of FIGS. 1-4 may each be constructed to have a variety of masses. Merely, by way of example, weights of the type illustrated in FIGS. 1-3 may be constructed in one-quarter, three-eighths, one-half, three-fourths and one ounce sizes. As another example, the weights of the type shown in FIG. 4 may be produced in one-eighth, three-sixteenths, one-fourth, three-eighths, one-half, three-fourths and one ounce sizes. However, it will be appreciated that the invention is not limited to these specific masses. For example, both smaller and larger sized weights may be produced.

Referring now to FIGS. 5-8, one apparatus that may be employed to produce weights of the type shown in FIG. 4 will be described. The apparatus illustrated in FIGS. 5-8 may also be employed to produce the weights of FIGS. 1-3 simply by changing the shape of the ejector and punch as described hereinafter.

As shown in FIGS. 8A and 8B, a dye 44 is provided having an outer member 46 and an inner member 48 which defines a chamber 50. Use of inner member 48 is advantageous in that it may be replaced with other inner members having different sized chambers so that the size of a resulting weight may be varied simply by providing a different sized chamber. Insertable into one end of chamber 50 is an ejector 52 as shown in FIGS. 5A and 5B. Ejector 52 has a proximal end 54 and distal end 56. Distal end 56 is insertable into chamber 50 and includes a shaped surface 58. Shaped surface 58 is employed to form one end of the weight. For example, shaped surface 58 of FIG. 5B may be employed to produce pointed tip 38 of the weight of FIGS. 4A and 4B. In order to change the shape of the end of the weight, distal end 56 may be replaced with another distal end having a different shaped surface. Hence, the same die may be used with multiple ejectors to form different shaped weights.

Extending between proximal end 54 and distal end 56 is an opening 60. Insertable through opening 60 is a core rod 62 as shown in FIGS. 7A and 7B. Core rod 62 is coupled to a housing 64 that is receivable into a cavity 66 within ejector 52. When housing 64 is received into cavity 66, core rod 62 extends distally beyond distal end 56. In this way, core rode 62 is centrally positioned within chamber 50 (see FIG. 8B) and forms a through hole in the weight. For example, core rod 62 may be employed to produce through hole 42 of the weight of FIG. 4B. To change the size or shape of the through hole, core rod 62 may simply be replaced with a core rod having a different size or shape.

FIGS. 6A and 6B illustrate a punch 68. Punch 68 has a proximal end 70 and a shaped distal end 72. Distal end 72 is insertable into chamber 50 (see FIG. 8B) at an end opposite to ejector 52 (see FIGS. 5A and 5B). Distal end 72 includes a shaped surface 74 that is employed to form the opposite end of the weight. For example, shaped surface 74 may be employed to produce end 40 of the weight of FIG. 4B. However, it will be appreciated that distal end 72 may be replaced with other distal ends having different shaped surfaces to provide different shaped ends on the weights. Punch 68 includes an opening 76 which may receive core rod 62 (see FIGS. 7A and 7B) so that core rod 62 may extend completely through the green body.

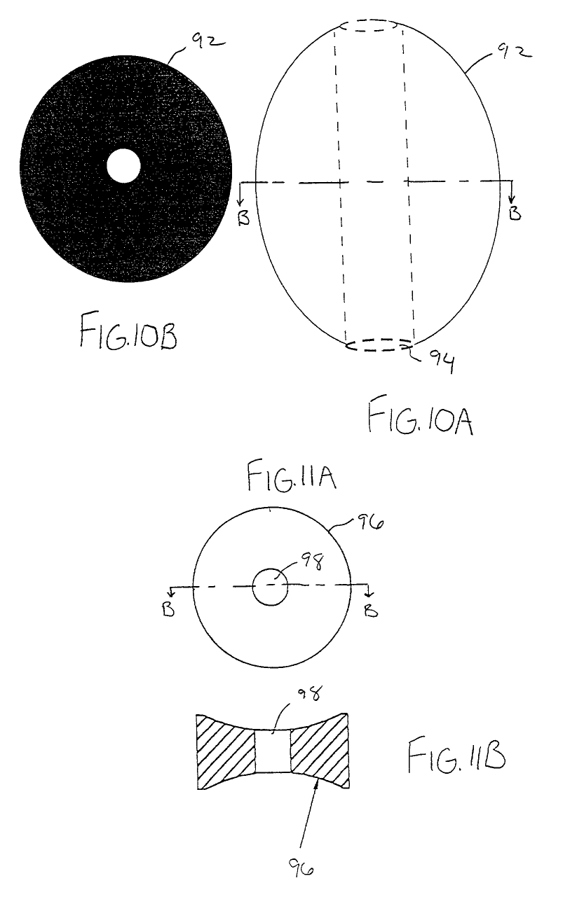

Referring now to FIG. 9 in connection with FIGS. 5-8, one method for forming a weight will be described. As shown in step 78, a composition of tungsten powder and binder is selected. This composition may be any of the compositions described herein. Ejector 52 (see FIG. 5B) is inserted into one end of chamber 50 (see FIG. 8B). Core rod 62 (see FIG. 7B) is inserted through opening 60 of ejector 52 until housing 64 is within the cavity 66. In this way, core rod 62 will extend distally beyond distal end 56 and into chamber 50.

As shown in step 80, the composition is poured into the die. Punch 68 (see FIG. 6B) is inserted into an opposite end of chamber 50 and is moved toward ejector 52 to compress the composition to form a green body. The length of the green body depends in part on the amount of composition poured into chamber 50 and the amount of pressure applied to the green body. Typically, pressures that may be employed to form the green body are in the range from about 1 ton to about 5 tons. As punch 68 is moved through chamber 50, core rode 62 passes into opening 76. In this way, core rod 62 extends completely through the green body. The compressing step is illustrated in step 82 of FIG. 9.

As shown in step 84, once the green body has been formed, punch 68 is removed from chamber 50 and ejector 52 is moved further into chamber 50 to eject the green body from chamber 50.

As shown in step 86, the green body is then placed in an oven and fired to produce the weight. In one aspect, the green body may be placed in a vacuum oven and heated to a temperature in the range from about 1450° C. to about 1490° C. for a time period in the range from about 2 hours to about 4 hours.

Once the weight has been formed, it is removed from the oven and optionally tumbled in an abrasive slurry as shown in step 88. In this way, any sharp edges on the weight may be removed. As a final step, the weight may be washed as shown in step 90.

It will be appreciated that the apparatus illustrated in FIGS. 5-8 is merely one type of apparatus that may be employed to produce weights. For example, other dies having other shapes and other types of ejectors and punches may be employed to form different sized and shaped weights. Merely, by way of example, one alternative weight 92 is shown in FIGS. 10A and 10B. Weight 92 is generally oval in geometry and has a through hole 94. Weight 92 may be constructed using an apparatus having punch and ejectors appropriately shaped to form the oval geometry.

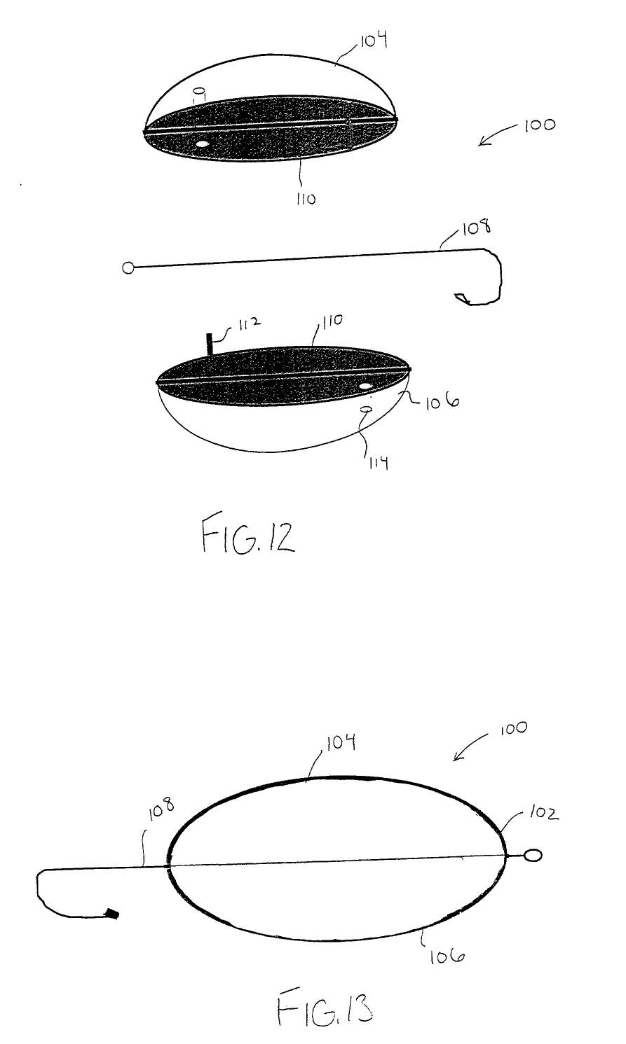

Shown in FIGS. 11A and 11B is a clacker 96 that may optionally be used in connection with a fishing weight. Clacker 96 may include a through hole 98 that allows clacker 96 to be inserted over a fishing line. Clacker 96 may be placed adjacent a fishing weight so that as the fishing line is pulled through the water, clacker 96 will periodically contact the fishing weight to produce sound waves within the water to help attract fish. Clacker 96 may be constructed using any of the materials previously described in connection with the fishing weights described herein. Conveniently, clacker 96 may be produced using a die and punch/ejector arrangement similar to other embodiments described herein. In use, clacker 96 may be provided with an outer diameter that is essentially the same as the outer diameter of the associated fishing weight.

Referring now to FIGS. 12 and 13, an alternative use of fishing weights will be described. FIGS. 12 and 13 illustrate a jig 100 having a body 102 that is constructed of two pieces 104 and 106 which are disposed about a hook 108. Pieces 104 and 106 may be constructed of any of the tungsten compositions described herein. Pieces 104 and 106 each include a groove 110 for receiving the shank of hook 108. Optionally, each of the pieces may include a peg 112 and a hole 114 which mate with each other when the two pieces are placed adjacent each other. A variety of schemes may be employed to secure the two pieces together, such as gluing, bonding, and the like.

Body 102 may be constructed to have essentially any shape and/or size depending on the desired jig configuration. One way to form pieces 104 and 106 is by employing a die that is similar to the die of FIG. 8 except that the die includes a flat surface. Further, two pins may be inserted into the die normal to the central axis after the die has been filled with the composition. In this way, each resulting green body will have two holes. After firing, one of the holes may be press fit with peg 112.

Although not shown, various other components may be secured to hook 108 and/or body 104. For example, various feathers, attractors, and the like may be included as is known in the art.

It will be appreciated that the weights of the invention may also be configured to be coupled to other types of fishing lures. For example, weights may be configured to be attached to spinner bates, flies, plugs, and the like. The particular configuration of the weights and the manner in which they are attached to their associated hooks may be varied depending on the particular application.

### EXAMPLE

The following is a non-limiting example of one weight that was produced according to the principles of the invention. The apparatus used to construct the weight was essentially identical to the apparatus shown in FIGS. 5-8. The weight was a bullet type weight as illustrated in FIGS. 4A and 4B. The green body was formed from a composition of tungsten powder and nickel powder. The tungsten powder was 93.95 wt. % and the nickel powder was 6.04 wt. %. The composition used to form the green body was 6% Ni Grade composition, commercially available from Osram. Added to the composition of tungsten and nickel was 2.4% wax. The powder was compressed at a pressure of 1 ton for about 3 seconds. The green body was then removed from the die and sintered at a temperature of 1475° C. for 90 minutes. The resulting weight was then tumbled in an abrasive slurry of silicon carbide and then washed. The resulting weight had a hardness of 92.7 (HRA) and a hardness of 16.9 (HV). The density was 14.96 g/cc. The weight weighed approximately 3/16 ounce.

The invention has now been described in detail for purposes of clarity of understanding. However, it will appreciated that certain changes and modifications may be practiced within the scope of the appended claims.

What is claimed is:

1. A method for producing a fishing weight, comprising:
placing a composition comprising tungsten powder in major amount and a binder in minor amount into a die;
compressing the composition within the die to form a green body;
removing the green body from the die; and
heating the green body to form a fishing weight.

2. A method as in claim 1, wherein the composition comprises about 80 wt percent to about 97 wt percent tungsten powder, about 20 wt percent to about 3 wt percent nickel binder, and about 1 wt percent to about 3 wt percent paraffin.

3. A method as in claim 1, further comprising tumbling the fishing weight in an abrasive slurry after being removed from the die.

4. A method as in claim 3, further comprising washing the fishing weight following the tumbling step.

5. A method as in claim 1, further comprising heating the green body to a temperature in the range of about 1450 degrees C. to about 1490 degrees C.

6. A method as in claim 1, further comprising compressing the composition to a pressure in the range from about 1 ton to about 5 tons.

7. A method as in claim 1, wherein the die is cylindrical in geometry and wherein the compressing step comprises placing a punch into one end of the cylinder and an ejector into an opposite end of the cylinder and compressing the powder between the punch and the ejector.

8. A method as in claim 7, further comprising moving the ejector through the die to remove the fishing weight.

9. A method as in claim 7, further comprising placing a center rod along a central axis of the die to form a central hole in the fishing weight.

10. A fishing weight produced according to the steps of:
placing a composition comprising a tungsten powder in major amount and a binder in minor amount into a die;
compressing the composition within the die to form a green body having a through hole;
removing the green body from the die; and
heating the green body to form a fishing weight.

11. A fishing weight as in claim 10, wherein the composition comprises about 80 wt percent to about 97 wt percent tungsten powder, about 20 wt percent to about 3 wt percent nickel binder, and about 1 wt percent to about 3 wt percent paraffin.

12. A fishing weight as in claim 10, wherein the green body is heated to a temperature in the range from about 1450 degrees C. to about 1490 degrees C.

13. A fishing weight as in claim 10, wherein the die is cylindrical in geometry and wherein the compressing step comprises placing a punch into one end of the cylinder and an ejector into an opposite end of the cylinder and compressing the powder between the punch and the ejector.

14. A fishing weight as in claim 10, further produced according to the step of placing a center rod along a central axis of the die to form the through hole in the green body.

15. A fishing weight comprising:
a body having a defined outer shape and an opening extending through the body, wherein the opening is adapted to receive a fishing line, and wherein the body is constructed from a composition comprising tungsten in major amount and a nickel binder in minor amount.

16. A fishing weight as in claim 15, wherein the composition comprises about 80 wt percent to about 97 wt percent tungsten powder and about 20 wt percent to about 3 wt percent nickel binder.

17. A fishing weight as in claim 15, wherein the body has a center section that is cylindrical in geometry.

18. A fishing weight as in claim 17, wherein the body has two ends and wherein the ends have a geometry selected from a group consisting of concave, pointed and convex.

19. A fishing weight as in claim 15, wherein the body is spherical in geometry.

20. A fishing weight as in claim 19, wherein the opening has a diameter in the range from about 0.035 inch to about 0.080 inch.

21. A method for fishing, comprising:
providing a pole having a reel and a line;
providing a weight comprising a body having a defined outer shape and an opening extending through the body, and wherein the body is constructed from a composition comprising tungsten in major amount and a nickel binder in minor amount;
inserting the line through the opening;
securing a hook on the end of the line; and
casting the hook and the weight into a body of water.

22. A method as in claim 21, further comprising placing a disk onto the line prior to securing the hook, and pulling the line through the water to permit the disk to interact with the weight.

23. A method as in claim 22, wherein the disk has a diameter approximately equal to a diameter of the weight.

24. A method as in claim 22, wherein the disk is constructed of a material that is approximately the same as the material of the weight.

25. A fishing lure comprising:
a hook; and
a body coupled to the hook, wherein the body is constructed from a composition comprising tungsten in major amount and a nickel binder in minor amount.

26. A fishing lure as in claim 25, wherein the body includes two sections that are coupled to each other about the hook.

27. A method for making a fishing lure, the method comprising:
providing a hook;
positioning two tungsten carbide pieces about the hook; and
securing the two tungsten carbide pieces together.
